(19) United States
(12) Patent Application Publication
(10) Pub. No.: US 2007/0297639 A1
(43) Pub. Date: Dec. 27, 2007

(54) Multiple magnet loudspeaker

(76) Inventor: Michael A. Noll, Columbus, IN (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/471,966

(22) Filed: Jun. 21, 2006

(51) Int. Cl. H04R 9/06; H04R 1/00; H04R 11/02

(52) U.S. Cl. 381/421; 381/401

(57) ABSTRACT

A multiple magnet dual-gap loudspeaker may generate increased magnetic flux to drive voice coils generating sound from the loudspeaker. The dual-gap dual-voice-coil loudspeaker allows enhanced loudspeaker performance. The dual-gap loudspeaker includes a frame supporting the loudspeaker, at least two voice coils resiliently mounted to the loudspeaker frame by a former, a center support positioned within the voice coils, and at least two magnets. The magnetic flux from each of the magnets is directed within the gaps formed between the center support and the voice coils.

### BACKGROUND

1. Technical Field

The invention relates to loudspeakers. In particular, the invention relates to dual voice coil loudspeakers with multiple magnets.

2. Related Art

Loudspeaker design focuses on providing a required performance for a given size factor. Achieving the performance goals may be based on many factors. One of these factors may include a flux in a magnetic gap of the loudspeaker driver. Conventional dual gap loudspeakers may use a single magnet with two voice coils surrounding the single magnet. These conventional solutions attempt to increase the magnetic flux available to interact with the voice coils in producing sound from the loudspeaker. Different materials and sizes of the single magnet may also affect magnetic flux in the system, and thus may affect the performance of the loudspeaker.

Loudspeaker drivers may use neodymium magnets to provide the magnetic flux. If the flux in the magnetic gap is to be increased for a neodymium driver in a loudspeaker, a designer may consider two principal options. One option is to increase the material magnetic strength and/or increase the size of the magnet. For a neodymium design with a 9.0 mm thick magnet, the single magnet design may have a peak magnetic field (B) value of 0.80 Tesla (T). Adding two such 9.0 mm thick magnets together may increase the peak value to 1.17 T. For a ceramic motor, a diameter of the magnet may be increased, but this increases the weight of the overall loudspeaker. For a similar ceramic magnet design, a single 9.0 mm magnet may have a peak B value of 0.62 T. Adding two such 9.0 mm thick magnets may increase the peak B value to 0.74 T. A designer who desires a higher magnetic flux in a single magnet motor must therefore increase the size of the magnets, which may be prohibitive in a given loudspeaker design, or use materials with higher magnetic strength, which may not be possible or cost-effective. Therefore a need exists for a motor for a loudspeaker that provides high magnetic flux.

### SUMMARY

A multiple-gap multiple-voice-coil loudspeaker is disclosed that provides increased magnetic flux to drive the voice coils generating sound from the loudspeaker. The multiple-gap loudspeaker includes a frame supporting the loudspeaker. The multiple-gap loudspeaker may include voice coils coupled to the loudspeaker frame by a former. A support may be positioned within the voice coils. The loudspeaker may include multiple magnets, such that the magnetic flux generated by the magnets may be directed within the gaps formed by the support and the voice coils. The multiple magnet loudspeaker may provide increased performance for a given magnet dimension, or a reduced weight for an equivalent performance factor.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a cross-section of an example loudspeaker.

FIG. 2 illustrates a cross-section of a second example loudspeaker.

FIG. 3 illustrates a cross-section of a third example loudspeaker.

FIG. 4 illustrates a cross-section of a fourth example loudspeaker.

FIG. 5 illustrates a cross-section of a fifth example loudspeaker.

FIG. 6 illustrates a plot of a magnetic field strength for a neodymium magnet loudspeaker.

FIG. 7 illustrates a plot of a magnetic field strength for a ceramic magnet loudspeaker.

FIG. 8 illustrates a plurality of magnetic fields for an example loudspeaker.

FIG. 9 illustrates an example process to manufacture a multiple-magnet loudspeaker.

### DETAILED DESCRIPTION OF THE PREFERRED EMBODIMENTS

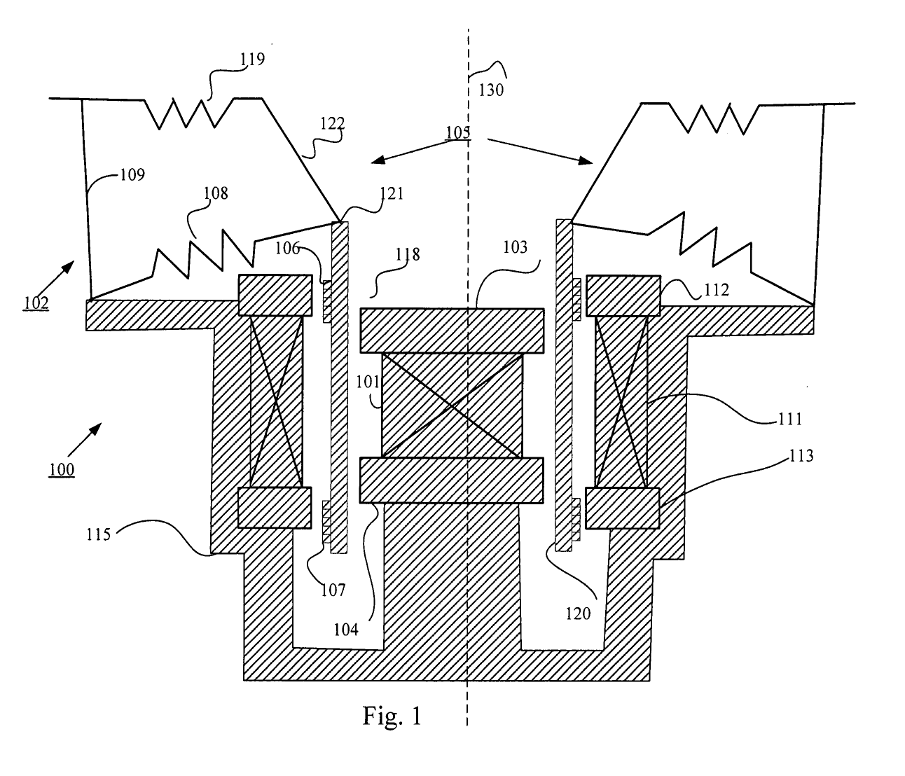

FIG. 1 illustrates a cross-section of an example multiple-magnet loudspeaker 100. The loudspeaker 100 may include a frame 102, which may include a basket portion 109, a vibratable voice coil/diaphragm assembly 105, and a support 115. The voice coil assembly 105 may include a voice coil former portion 121 coupled with voice coils (106 and 107). A conical diaphragm portion 122 may be resiliently suspended from the frame 102 by resilient suspension members (108 and 119) known as “surround” and “spider” suspensions respectively, which may allow the voice coil assembly 105 to vibrate along a central axis 130. The assembly 105 is shown at its quiescent center position, where voice coils (106 and 107) each may have a portion located in a magnetic gap (118 and 120), and these portions may be acted upon over the full length of the magnetic gap (118 and 120).

The voice coils (106 and 107) may move along the central axis 130 during operation when magnetic fields interact with current flowing through the voice coils (106 and 107) due to a Lorentz force. The voice coils (106 and 107) may provide a movement along the central axis 130 during which the drive force and damping of the voice coil/diaphragm assembly 105 may remain relatively constant. This may ensure linear operation of the loudspeaker 100. The loudspeaker 100 also may include one or more center pole pieces (103 and 104) coupled magnetically with the voice coils (106 and 107) and coupled with the support 115. The loudspeaker 100 may include one or more magnets (101 and 111). Magnetic flux from each of the magnets (101 and 111) may be directed within the gaps (118 and 120) formed between the center pole pieces (103 and 104) and the voice coils (106 and 107). A main support 115 may be coupled with the basket portion 109 of the frame.

In the loudspeaker 100, the first magnet 101 may be disposed between the first center pole piece 103, at a north pole of magnet 101 (an end of the magnet 101 proximate to the first center pole piece 103), and the second center pole piece 104 at a south end of magnet 101 (an end of the magnet 101 proximate to the first center pole piece 104). A second magnet 111 may be positioned outside the first and second voice coils (106 and 107). The first magnet 101 and the second magnet 111 may be composed of magnetic materials such as neodymium, iron, composite materials and/or ceramic materials. The first and second center pole pieces (103 and 104) may be composed of steel or other low reluctance materials. The first magnet 101 may be directly coupled to the first and second center pole pieces 103 and 104.

The second magnet 111 may be coupled to one or more support magnetic yokes (112 and 113). The second magnet 111 and the magnetic yokes (112 and 113) are coupled with the support 115 and positioned outside of the voice coils (106 and 107). The magnetic yokes (112 and 113) may be composed of a low reluctance magnetic material, such as steel or other alloy(s). The magnetic yokes (112 and 113) may provide a low-reluctance path for at least a portion of the magnetic flux generated by the first magnet 101 and the second magnet 111 to be channeled through. The magnetic yokes (112 and 113) may complete a magnetic circuit formed by the first magnet 101, the second magnet 111, and the gaps (118 and 120). The magnetic yokes 112 and 113 may cooperatively operate with the magnets 101 and 111 to create a high concentration of magnetic flux in the magnetic circuit. Accordingly, the voice coils 106 and 107 may be subject to the high concentration of magnetic flux, resulting in improved performance of the loudspeaker 100. The loudspeaker 100 may accomplish the high concentration of magnetic flux without using the magnetic yokes (112 and 113).

The loudspeaker 100 may be symmetric about the central axis of symmetry 130. For example, the first magnet 101 may be cylindrically symmetric about an axis 130 passing through the center of the first magnet 101 and the center pole pieces (103 and 104). The second magnet 111 may be configured to surround the first magnet 101 and the voice coils (106 and 107), in the form of an annulus. The loudspeaker 100 may also be formed in other configurations including non-symmetrical configurations. The first magnet 101 and the center pole pieces (103 and 104) may be stacked upon a pedestal formed in the support 115.

In FIG. 1, the support 115 may include structures that couple the elements of the loudspeaker 100. The support 115 may be configured with shoulders or grooves to couple the magnetic yokes (112 and 113). The support 115 may include fasteners to couple the second magnet 111 and the magnetic yokes (112 and 113) to the support 115, such as adhesives, bonding agents, or mechanical fasteners. The support 115 may include a central pedestal to couple the center pole pieces (103 and 104) and the first magnet 101 to the support 115. The support 115 may include a groove or sleeve in which the center pole pieces (103 and 104) and the first magnet 101 may be positioned or coupled with the support 115. The support 115 may be indirectly coupled to the center pole pieces 103 and 104 as well. The support 115 may also include cone connection struts or joints that couple the basket 109 and/or the resilient member 108.

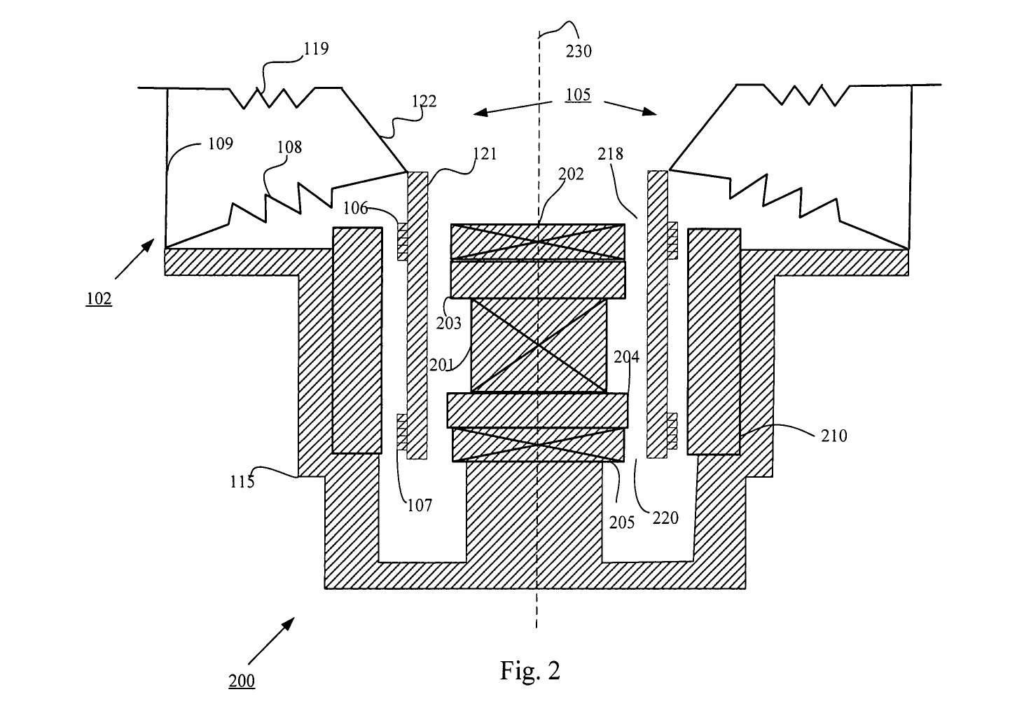

FIG. 2 illustrates a cross-section of a second example loudspeaker 200. The loudspeaker 200 may include a first magnet 201. A first center pole piece 203 and a second center pole piece 204 may be coupled with the first magnet 201. The first pole piece 203 may be positioned on a first side of the first magnet 201 (such as a north pole of the first magnet 201), and the second center pole piece 204 may be positioned on a second side of the first magnet 201 (such as a south pole of the first magnet 201), where the second side is opposite the first side of the first magnet 101.

A second magnet 202 may be positioned proximate to the first center pole piece 203, which may be proximate to the first magnet 201. The second magnet 202 may be separated from the first magnet 201 by the first center pole piece 203. A third magnet 205 may be positioned proximate to the second center pole piece 204 and coupled to the support 115. The second center pole piece 204 may be proximate to the first magnet 201 and opposite to the second magnet 202. The third magnet 205 may be separated from the first magnet 201 by the second center pole piece 204. The first magnet 201, the second magnet 202, and the third magnet 205 may be composed of magnetic materials such as neodymium, iron, composite materials and/or ceramic materials. The center pole pieces (203 and 204) may be composed of steel or other low-reluctance materials.

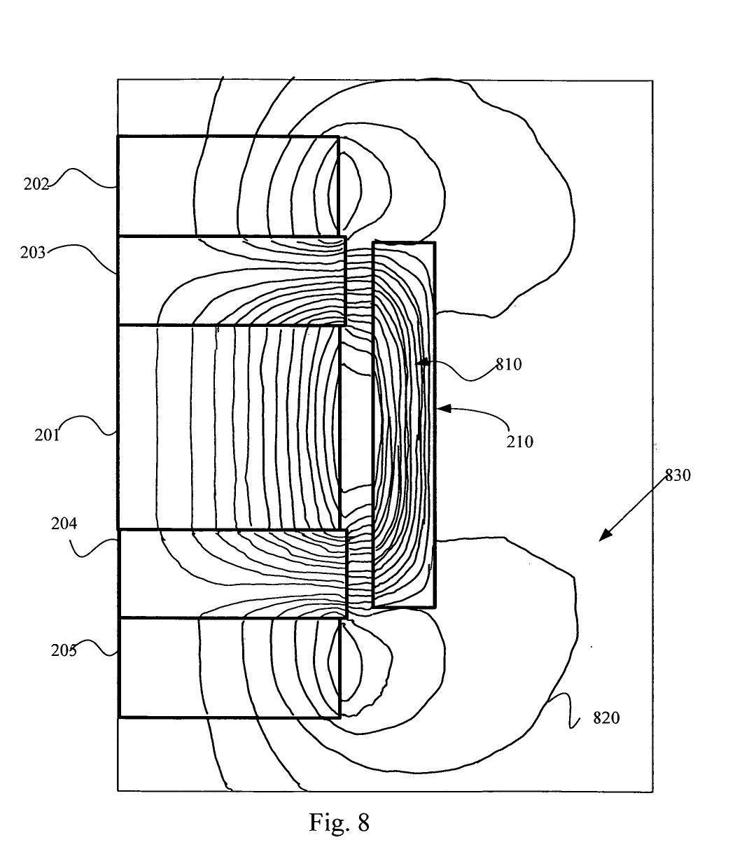

The loudspeaker 200 may also include a magnetic yoke 210 positioned outside of the voice coils (106 and 107). The magnetic yoke 210 may direct a portion of the magnetic flux of the magnets (201, 202, and 205) through the magnetic yoke 210. FIG. 8 illustrates a magnetic flux diagram. In FIG. 8, the region within the magnetic yoke 210 may include a higher concentration of magnetic flux lines 810 than a concentration of magnetic flux lines 820 in a region 830 outside of the magnetic yoke 210. The magnetic yoke 210 may be composed of a low reluctance magnetic material, such as steel. The magnetic yoke 210 may be configured to provide a low-reluctance path for the magnetic flux generated by the first magnet 201, the second magnet 203, and the third magnet 205 to be channeled through. The magnetic yoke 210 may complete a magnetic circuit formed by the first magnet 201, the second magnet 203, the third magnet 205, and the gaps (218 and 220) formed by the center pole pieces (203 and 204) and the first and second voice-coils (106 and 107). The gaps 218 and 220 may be of different dimensions from the gaps 118 and 120 described in FIG. 1. In addition, a magnetic flux diagram representative of the flux concentrating operation of the magnetic yokes 112 and 113 included in the example loudspeaker 100 of FIG. 1 could also be illustrated. The loudspeaker 100 may accomplish the high concentration of magnetic flux without using the magnetic yokes (112 and 113) as well.

The loudspeaker 200 may be symmetric about an axis of symmetry 230. For example, the first magnet 201, the second magnet 203, and the third magnet 205 may be cylindrically symmetric about an axis 230 passing through the center of the first magnet 201 and the center pole pieces (202 and 203). The magnetic yoke 210 may be configured to concentrically surround the center pole pieces (202 and 203) and the voice coils (106 and 107) in the form of an annulus. The loudspeaker 200 may also be formed in other configurations including non-symmetrical configurations.

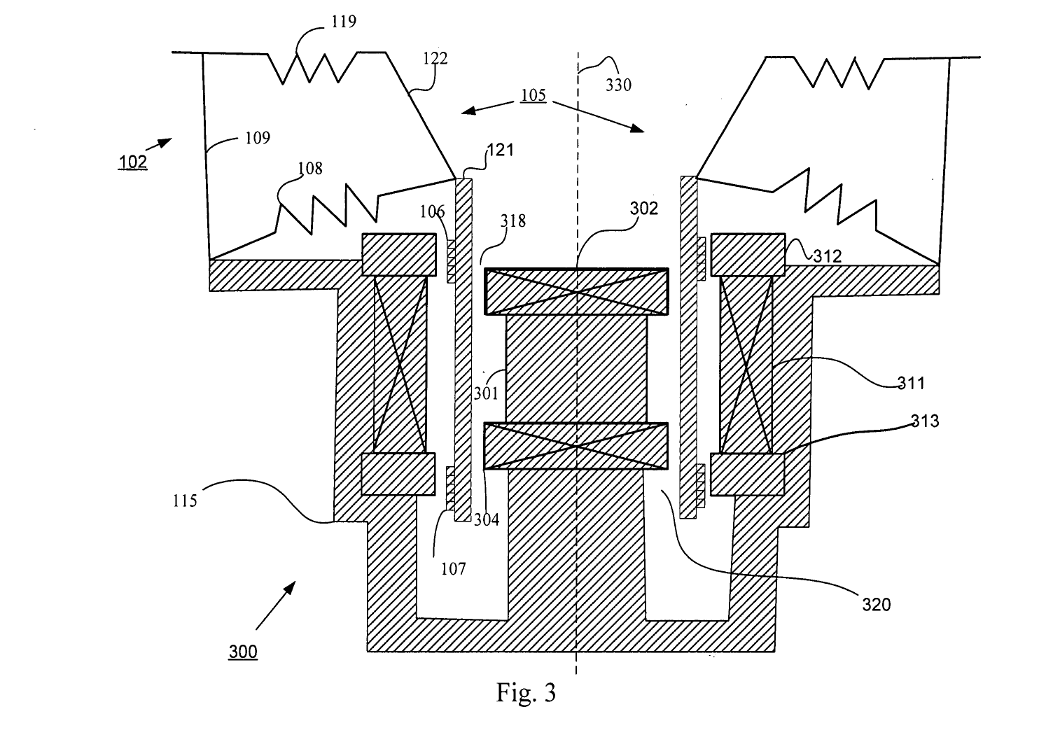

FIG. 3 illustrates a cross-section of a third example loudspeaker 300. The loudspeaker 300 may include a central pole piece 301. The loudspeaker 300 may include a first magnet 302 and a second magnet 304 coupled with the support 115. The first magnet 302 may be coupled with a first side of the center pole piece 301. The second magnet 304 may be coupled with a second side of the center pole piece 301, opposite the first magnet 302. A third magnet 311 may be positioned outside the voice coils (106 and 107). The loudspeaker 300 may include a first magnetic yoke 312 and a second magnetic yoke 313. The first magnetic yoke 312 may be coupled proximate to a first side of the third magnet 311 (such as a north pole of the third magnet 311), and the second magnetic yoke 313 may be coupled proximate to a second side of the third magnet 311 (such as a south pole of the third magnet 311), and opposite to a first side of the magnetic yoke 312. The first magnet 302, second magnet 304, and the third magnet 311 may be composed of magnetic materials such as neodymium, iron, composite materials and/or ceramic materials.

The magnetic yokes (312 and 313) may be coupled with the support 115, where the magnetic yokes 312 and 313 direct a portion of the magnetic flux of the magnets through the magnetic yokes (312 and 313). As described in connection with FIG. 2, FIG. 8 illustrates a magnetic flux diagram. FIG. 8 schematically illustrates a higher concentration of magnetic flux lines 810 present in the region of the magnetic yoke 210 compared to a concentration of magnetic flux lines 820 present in a region 830 outside of the magnetic yoke 210. The magnetic yoke 210 may function similarly to the magnetic yokes (312 and 313) as illustrated in FIG. 3, such that the magnetic yokes 312 and 313 direct the magnetic flux of the magnets (311, 302, and 304). The magnetic yokes 312 and 313 are positionable outside of the voice coils (106 and 107). The magnetic yokes 312 and 313 may be composed of a magnetic material, such as steel or other alloy(s). The magnetic yokes (312 and 313) may be configured to provide a low-reluctance path for the magnetic flux generated by the first magnet 302, the second magnet 304, and the third magnet 311 to be channeled through. The magnetic yokes (312 and 313) may complete a magnetic circuit formed by the first magnet 302, the second magnet 304, the third magnet 311, and the gaps (318 and 320) formed by the first magnet 302, the second magnet 304, and the first and second voice-coils (106 and 107). The gaps (318 and 320) may be of different dimensions from the dimensions of the gaps illustrated in FIGS. 1-2. The loudspeaker 100 may accomplish the high concentration of magnetic flux without using the magnetic yokes (312 and 313) as well.

The loudspeaker 300 may be symmetric about an axis of symmetry 330. For example, the first magnet 302, the second magnet 304, and the third magnet 311 may be cylindrically symmetric about an axis 330 passing through the center of the first magnet 302 and the center pole piece 301. The third magnet 311 and the first and the second magnetic yokes (312 and 313) may be configured to concentrically surround the center pole piece 301 and the voice coils (106 and 107) in the form of an annulus. The loudspeaker 300 may also be formed in other configurations, including non-symmetrical configurations.

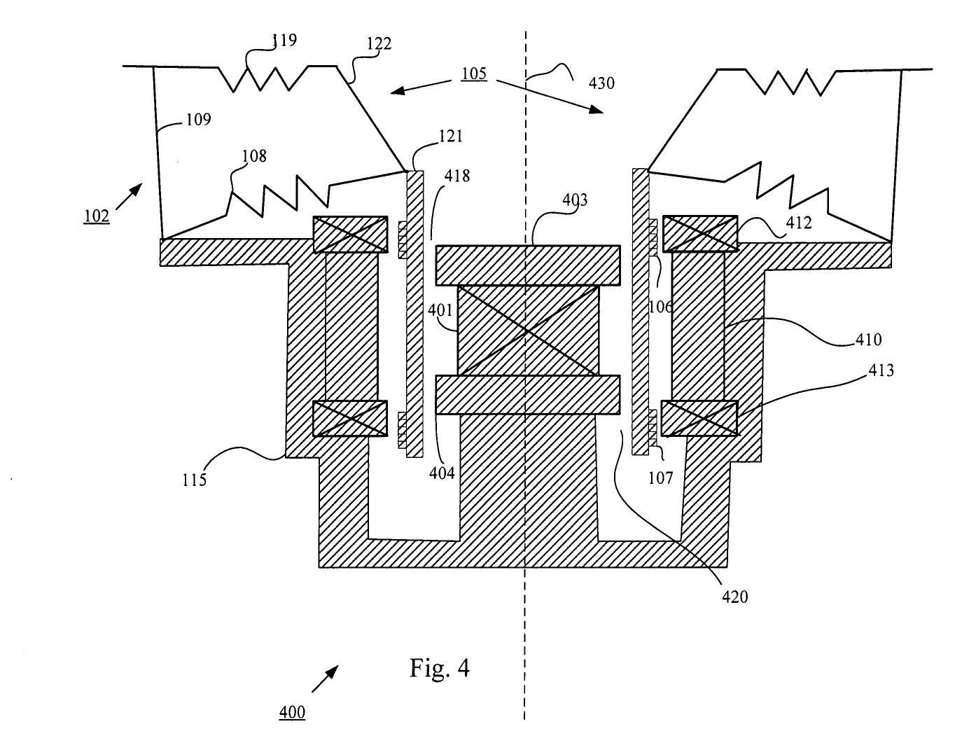

FIG. 4 illustrates a cross-section of a fourth example loudspeaker 400. The loudspeaker 400 may include a first magnet 401 coupled with the support 115, a second magnet 412 positioned outside the voice coils (106 and 107), and a third magnet 413 positioned outside the voice coils (106 and 107). The first voice coil 106 may be positioned between the first magnet 401 and the second magnet 412. The third magnet 413 is positioned such that the second voice coil 107 is positioned between the first magnet 401 and the third magnet 413. The first magnet 401, the second magnet 412, and the third magnet 413 may be composed of magnetic materials such as neodymium, iron, composite materials and/or ceramic materials.

The loudspeaker 400 may include a magnetic yoke 410. The magnetic yoke 410 may direct a portion of the magnetic flux of the magnets (401, 412, and 413) through the magnetic yoke 410. The magnetic yoke 410 is positioned outside of the voice coils (106 and 107). The magnetic yoke 410 may be composed of a magnetic material, such as steel or other magnetic iron alloy. The magnetic yoke 410 may be configured to provide a low-reluctance path for the magnetic flux generated by the first magnet 401, the second magnet 412, and the third magnet 413 to be channeled through. The magnetic yoke 410 may complete a magnetic circuit formed by the first magnet 401, the second magnet 412, the third magnet 413, and the gaps (418 and 420) formed by the center pole pieces (403 and 404) and the first and second voice-coils (106 and 107). The gaps 418 and 420 may be of different dimensions from the dimensions of the gaps illustrated in FIGS. 1-3. Within the magnetic circuit, the concentration of magnetic flux due to the magnetic yoke 410 may be increased. The loudspeaker 100 may accomplish the high concentration of magnetic flux without using the magnetic yoke 410 as well. For purposes of brevity, a magnetic diagram illustrating operation of the magnetic yoke 410 to concentrate the magnetic flux has been omitted.

The loudspeaker 400 may be symmetric about an axis of symmetry 430. For example, the first magnet 401, the second magnet 412, and the third magnet 413 may be cylindrically symmetric about an axis 430 passing through the center of the first magnet 401. The second magnet 412, the third magnet 413, and the magnetic yoke 410 may be configured to concentrically surround the center pole pieces (403 and 404) and the voice coils (106 and 107) in the form of an annulus. The loudspeaker 400 may also be formed in other configurations, including non-symmetrical configurations.

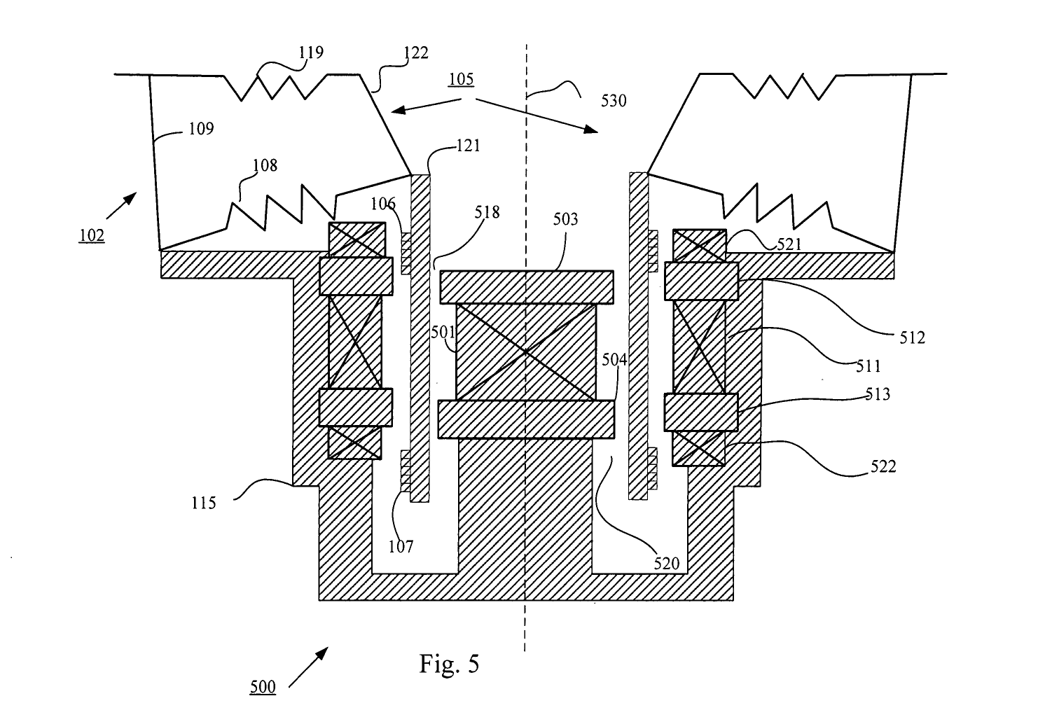

FIG. 5 illustrates a cross-section of a fifth example loudspeaker 500. The loudspeaker 500 may include a first magnet 501, coupled with a first center pole piece 503, a second center pole piece 504, and the support 115. A plurality of support magnets (511, 521, and 522) may be positioned outside of the voice coils (106 and 107). A first magnetic yoke 512 and a second magnetic yoke 513 may be surround the voice coils (106 and 107). A second magnet 511 may surround the first magnetic yoke 512 and the second yoke 513. A third magnet 521 may be coupled with a side of the first magnetic yoke 512 that is opposite the second magnet 511. A fourth magnet 522 may be coupled with a side of the second magnetic yoke 513 that is opposite the second magnet 511. The first magnet 501, the second magnet 511, the third magnet 521, and the fourth magnet 522 may be composed of magnetic materials such as neodymium, iron, composite materials and/or ceramic materials. The magnetic yokes (512 and 513) may be composed of a low-reluctance material such as steel or iron.

The magnetic yokes (512 and 513) may be configured to direct a portion of the magnetic flux of the magnets (501, 511, 521, and 522) through the magnetic yokes 512 and 513, as illustrated schematically in FIG. 8 (where the magnetic yokes 512 and 513 may function similarly to the magnetic yoke 210). The magnetic yokes 512 and 513 are positioned outside of the voice coils (106 and 107). The magnetic yokes 512 and 513 may be configured to provide a low-reluctance path for the magnetic flux generated by the magnets (501, 511, 521, and 522) to be channeled through. The magnetic yokes 512 and 513 may be configured to complete a magnetic circuit formed by the first magnet 501, the second magnet 511, the third magnet 521, the fourth magnet 522, and the gaps (518 and 520) formed by the center pole pieces (503 and 504) and the first and second voice-coils (106 and 107). The gaps 518 and 520 may be of different dimensions from the gaps illustrated in FIGS. 1-4. The magnetic yokes 512 and 513 may cooperatively operate with the magnets 501, 511, 521, and 522, and the pole pieces 503 and 504 to increase the concentration of magnetic flux in the magnetic circuit and the gaps 518 and 520. For purpose of brevity a magnetic flux diagram has been omitted. The performance of the voice coils 106 and 107 may be improved due to the increased flux concentration to which they are subject. The loudspeaker 100 may accomplish the high concentration of magnetic flux without using the magnetic yokes (512 and 513) as well.

As in the loudspeakers illustrated in FIGS. 1-4, the loudspeaker 500 may be symmetric about an axis of symmetry 530. For example, the first magnet 501, the second magnet 511, and the third and fourth magnets (521 and 522) may be cylindrically symmetric about an axis 530 passing through the center of the first magnet 501 and the first and second center pole pieces (503 and 504). The second magnet 511, the third magnet 521, the fourth magnet 522, and the magnetic yokes (512 and 513) may be configurable to concentrically surround the first center pole piece 503 and the second center pole piece 504 and the voice coils (106 and 107) in the form of an annulus. The loudspeaker 500 may also be formed in other configurations, including non-symmetrical configurations.

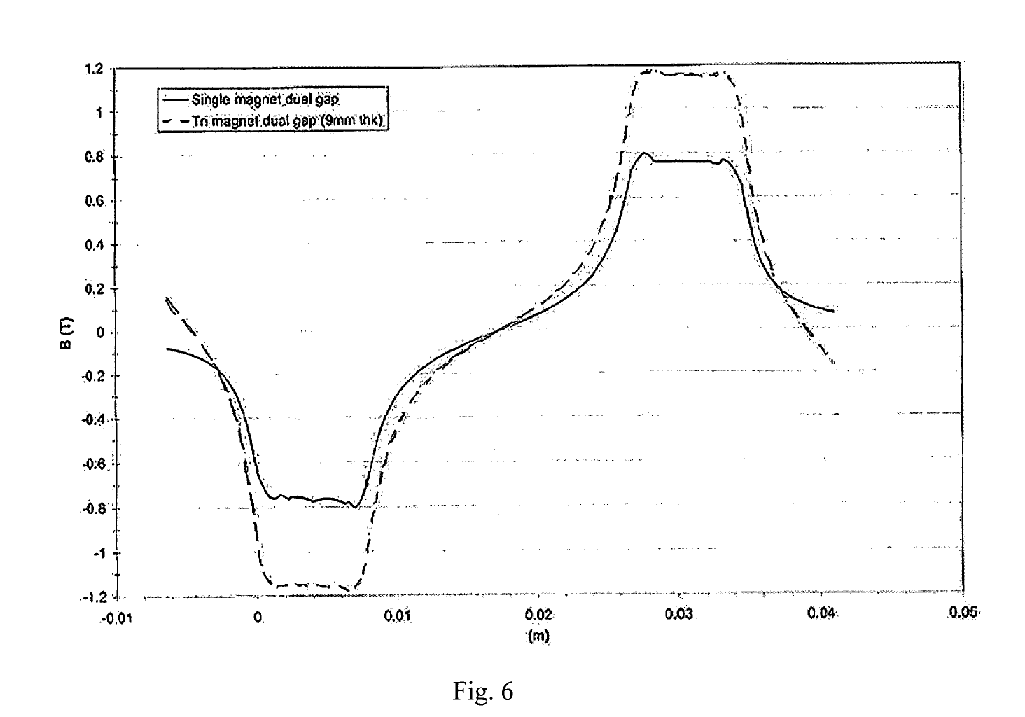

In FIGS. 1-5, the loudspeakers 100-500 may provide increased magnetic flux in the gaps (118 and 120) formed by the pole pieces (102, 103, 203, 204, 301, 403, 404, 503, and 504) and the first and second voice-coils (106 and 107) due to the combination of the magnets (101, 111, 201, 202, 205, 302, 304, 311, 401, 412, 413, 501, 511, and 522), the pole pieces (102, 103, 203, 204, 301, 403, 404, 503, and 504) and the magnetic yokes (112, 113, 210, 312, 313, 410, 512, and 513). FIG. 6 illustrates an example plot of a magnetic field strength B(T) for a loudspeaker 200 with neodymium magnets. FIG. 6 illustrates the magnetic field strength B(T) across the loudspeaker 200 as illustrated in FIG. 2, where the x-axis has its zero at the center of the loudspeaker 200 (the axis 230). The dashed curve depicted in FIG. 6 illustrates the results obtained from a tri-magnet dual-gap loudspeaker, such as the loudspeakers illustrated in FIGS. 2-4, while the solid curve illustrates the results obtained from a prior art single magnet dual-gap loudspeaker. The loudspeakers 200, 300, and 400 provide an increased magnetic field strength B(T) in the gaps (shown at 0.005 m and 0.035 m on the abscissa).

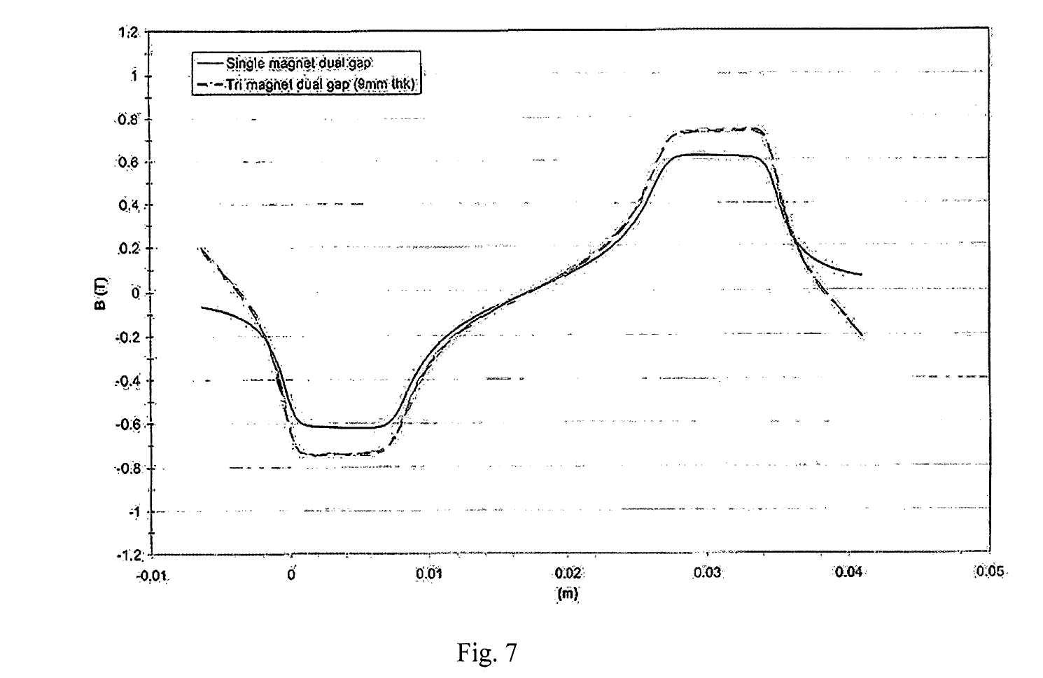

FIG. 7 illustrates a plot of a magnetic field strength B(T) for an example loudspeaker 200, as illustrated in FIG. 2, with ceramic magnets. FIG. 7 illustrates the magnetic field strength B(T) of the loudspeaker 200, where the zero of the x-axis indicates the center of the loudspeaker 200, at the axis 230. The dashed curve depicted in FIG. 7 illustrates the results obtained from a tri-magnet dual-gap loudspeaker, such as loudspeakers 200, 300, and 400 in FIGS. 2-4 while the solid curve illustrates the results obtained from a prior art single magnet dual-gap loudspeaker. The tri-magnet loudspeaker 200 may provide an increased magnetic field strength B(T) in the gaps (shown at 0.005 m and 0.035 m on the abscissa).

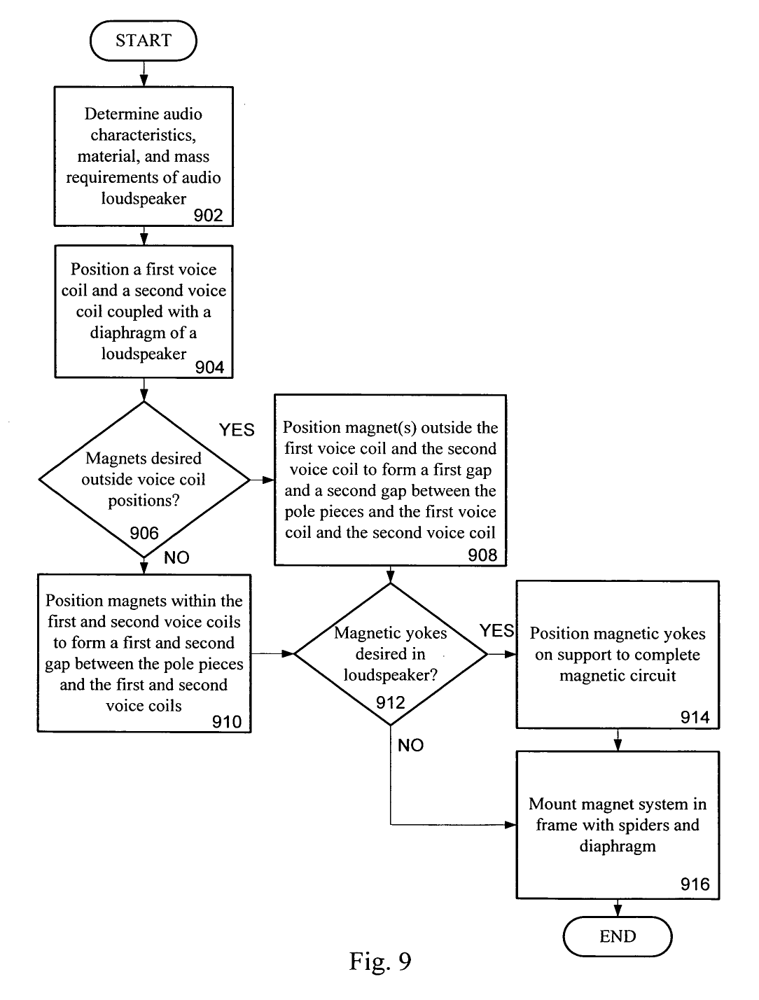

FIG. 9 illustrates example interrelated acts to manufacture a dual gap loudspeaker. Audio characteristics, material requirements, and mass/dimensional requirements of audio loudspeaker are determined (Act 902). Examples of audio performance characteristics include power dissipation for the audio channels, frequency ranges, and impedance of the loudspeaker elements. A developer may specify a maximum mass or dimensional requirement for an application or for a manufacturing process. A first voice coil and a second voice coil may be formed and coupled with a diaphragm of a loudspeaker (Act 904). The voice coils may be joined to a former and assembled with the diaphragm. The voice coils may be joined with a mechanical fastener, an adhesive, a weld or mounted in a groove or a sleeve on the former.

Next, it is determined if magnets are desired outside the voice coil positions (Act 906). Positioning of the magnets outside the voice coils may provide increased magnetic flux through the gaps between the voice coils and the pole pieces, which may enhance the audio performance, or allow reduced material usage and weight. If magnets are desired outside the voice coil positions, magnets may be positioned outside the first voice coil and the second voice coil (Act 908). The magnets may be coupled with a support, such as by mounting on a shoulder, in a groove, or fastened to a sleeve or slot. The magnets may be coupled with a mechanical fastener, or by an adhesive or a weld to the support.

If magnets are not desired outside of the voice coils, two or more magnets and one or more pole pieces may be positioned within the first and second voice coils to form a first gap and second gap between the pole pieces and the first voice coil and the second voice coil (Act 910). It is then determined if magnetic yokes are desired in the loudspeaker, based on the audio characteristics, material requirements, and mass/dimensional specifications (Act 912). A loudspeaker manufacturing process may require materials with mass and magnetic properties that allow a desired application or form factor. A placement of magnetic yokes may allow the production of a loudspeaker with the desired performance and dimensional attributes. If magnetic yokes are desired, magnetic yokes are positioned on the support sufficient to complete a magnetic circuit formed by the magnets, the magnetic yokes, and the gaps formed by the voice coils and the pole pieces (Act 914). If magnetic yokes are not desired, or after the magnetic yokes are positioned at Act 914, the loudspeaker may be assembled by forming a frame, a former to couple with the voice coils, and resilient members, such as spiders, to couple the former with the frame (Act 916). The frame and the former may be coupled to the support by struts, joints, or grooves. The frame and former may be joined by mechanical fasters, adhesives, or welds.

A multiple magnet loudspeaker may allow increased concentration of flux for a given design, or may allow a reduced mass loudspeaker for a given concentration of desired magnetic flux. The loudspeaker may include multiple magnets, such that the magnetic flux generated by the magnets may be directed within the gaps formed by the support and the voice coils.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A loudspeaker comprising:
a frame;
a first voice coil and a second voice coil resiliently coupled with the frame by a former;
one or more pole pieces positionable inside the first voice coil and the second voice coil to form at least two respective gaps between the one or more pole pieces and each of the first voice coil and the second voice coil; and
at least two magnets, where a magnetic flux from each of the at least two magnets is directed within the at least two gaps.

2. The loudspeaker of claim 1 where the at least two magnets comprise a first magnet and a second magnet, and where the first magnet is coupled with at least one of the one or more pole pieces and the second magnet is coupled with the frame outside of the first voice coil and the second voice coil.

3. The loudspeaker of claim 2 where the second magnet is substantially cylindrical.

4. The loudspeaker of claim 2 further comprising at least one magnetic yoke coupled to the second magnet and coupled with the frame, where the at least one magnetic yoke is operable to concentrate in the at least two gaps the magnetic flux of at least one of the at least two magnets through at least one of the at least one magnetic yoke.

5. The loudspeaker of claim 4 where the at least one magnetic yoke comprises a low-reluctance magnetic material.

6. The loudspeaker of claim 1 further comprising a frame;
where the one or more pole pieces comprise a first center pole piece and a second center pole piece, where the first center pole piece and the second center pole piece are indirectly coupled with the support and positioned within the first voice coil and the second voice coil; and
where the at least two magnets comprise a first magnet, a second magnet, and a third magnet, and where the first magnet is directly coupled with the first center pole piece and the second center pole piece, the second magnet is coupled with the second center pole piece opposite the first magnet, and the third magnet is coupled with the first center pole piece opposite the first magnet.

7. The loudspeaker of claim 6 further comprising a magnetic yoke positioned outside of the first voice coil and the second voice coil, where the magnetic yoke is operable to channel a magnetic flux of the first magnet, the second magnet, and the third magnet through the magnetic yoke into the gaps.

8. The loudspeaker of claim 1 further comprising a frame, where the one or more pole pieces comprises a central pole piece, where the central pole piece is directly coupled to the support inside the first voice coil and the second voice coil, and where the at least two magnets comprise a first magnet, a second magnet, and a third magnet, where the first magnet and the second magnet are directly coupled with the central pole piece, and the third magnet is coupled with the support.

9. The loudspeaker of claim 8 further comprising a first magnetic yoke and a second magnetic yoke, where the first magnetic yoke is coupled with a first side of the third magnet, and the second magnetic yoke is coupled with a second side of the third magnet, that is opposite the first side of the third magnet.

10. The loudspeaker of claim 9 where at least one of the first magnetic yoke or the second magnetic yoke is operable to channel a magnetic flux of at least one of the first magnet, the second magnet, or the third magnet through at least one of the first magnetic yoke or the second magnetic yoke into the gaps.

11. The loudspeaker of claim 10 where the third magnet is substantially cylindrical.

12. The loudspeaker of claim 1 further comprising:
a frame, and where the one or more pole pieces comprise a first center pole piece and a second center pole piece, where the at least two magnets include a first magnet, a second magnet, and a third magnet, and where the first magnet is coupled with the first center pole piece and the second center pole piece, the second magnet is coupled with the support such that the first voice coil is positioned between the first magnet and the second magnet, and where the third magnet is coupled with the frame such that the second voice coil is positioned between the first magnet and the third magnet into the gaps.

13. The loudspeaker of claim 12 further comprising a magnetic yoke coupled with the frame, where the magnetic yoke is operable to direct the magnetic flux of at least one of the first magnet, the second magnet, or the third magnet through the magnetic yoke.

14. The loudspeaker of claim 1 where the loudspeaker is configured for use in a vehicle.

15. The loudspeaker of claim 13 where the second magnet is substantially cylindrical.

16. The loudspeaker of claim 1 further comprising:
a frame; and
where the one or more pole pieces comprises a first center pole piece and a second center pole piece, where the at least two magnets comprise a first magnet, and three support magnets, where the first magnet is coupled with the first center pole piece and the second center pole piece, and where the three support magnets are coupled with the frame.

17. The loudspeaker of claim 16 further comprising a first magnetic yoke and a second magnetic yoke coupled with the support outside of the first voice coil and the second voice coil, and where the three support magnets comprise a first support magnet, a second support magnet, and a third support magnet, and where the first support magnet is coupled with the support between the first magnetic yoke and the second magnetic yoke, the second support magnet is coupled with the support on a side of the first magnetic yoke opposite the first support magnet, and where the third support magnet is coupled with a side of the second magnetic yoke opposite the first support magnet.

18. The loudspeaker of claim 17 where at least one of the first magnetic yoke or the second magnetic yoke is operable to concentrate the magnetic flux of at least one of the first magnet, the first support magnet, the second support magnet, or the third support magnet through at least one of the first magnetic yoke or the second magnetic yoke into the gaps.

19. A method of manufacturing a loudspeaker comprising:
providing a diaphragm of a loudspeaker;
coupling a first voice coil and a second voice coil with the diaphragm;
positioning one or more pole pieces inside the first voice coil and the second voice coil to form a respective first gap and a respective second gap between the one or more pole pieces and the first voice coil and the second voice coil;
coupling at least two magnets with at least one of the one or more pole pieces; and
assembling the diaphragm, the first voice coil, the second voice coil, the one or more pole pieces, and the at least two magnets within a frame.

20. The method of claim 19 further comprising concentrating a magnetic flux from the at least two magnets through the first gap and the second gap.

21. The method of claim 19 where the at least two magnets comprise a first magnet and a second magnet, and where coupling the at least two magnets comprises coupling the first magnet with at least one of the one or more pole pieces and positioning the second magnet outside of the first voice coil and the second voice coil.

22. The method of claim 19 further comprising coupling a support with the one or more pole pieces, where the one or more pole pieces comprise a first center pole piece and a second center pole piece, where the first center pole piece and the second center pole piece are indirectly coupled with the support and positioned inside the first voice coil and the second voice coil; and
where the at least two magnets comprise a first magnet, a second magnet, and a third magnet, and where coupling the at least two magnets comprises directly coupling the first magnet with the first center pole piece and the second center pole piece, directly coupling the second magnet with the second center pole piece opposite the first magnet, and directly coupling the third magnet with the first center pole piece opposite to the first magnet.

23. The method of claim 19 where the one or more pole pieces comprises a central pole piece further comprising indirectly coupling a support with the central pole piece inside the first voice coil and the second voice coil, and where the at least two magnets comprise a first magnet, a second magnet, and a third magnet, and where coupling the at least two magnets comprises directly coupling the first magnet and the second magnet with the central pole piece, and directly coupling the third magnet with the support.

24. The method of claim 19 where the one or more pole pieces comprise a first center pole piece and a second center pole piece, and where the at least two magnets comprise a first magnet, a second magnet, and a third magnet, and where coupling the at least two magnets comprises coupling the first magnet with the first center pole piece and the second center pole piece, and
where coupling the first voice coil and the second voice coil comprises positioning the first voice coil between the first magnet and the second magnet, and positioning the second voice coil between the first magnet and the third magnet.

25. A loudspeaker driving motor comprising:
a voice coil operable to drive a loudspeaker,
one or more pole pieces inside the voice coil to form at least two gaps between the one or more pole pieces and the voice coil; and
at least two magnets, where a magnetic flux from each of the at least two magnets is concentrated within the at least two gaps.

26. The loudspeaker driving motor of claim 25 where the at least two magnets comprise a first magnet and a second magnet, and where the first magnet is coupled with at least one of the one or more pole pieces and the second magnet is positioned outside of the voice coil.

27. The loudspeaker driving motor of claim 26 where the second magnet is coupled with a support.

28. The loudspeaker driving motor of claim 27 further comprising at least one magnetic yoke coupled to the second magnet and coupled with the support, where the at least one magnetic yoke is operable to direct the magnetic flux of at least one of the at least two magnets through the at least one magnetic yoke into the gaps.

29. The loudspeaker driving motor of claim 25 further comprising a support;
where the one or more pole pieces comprise a first center pole piece and a second center pole piece, where the first center pole piece and the second center pole piece are indirectly coupled with the support and positioned within the voice coil; and
where the at least two magnets comprise a first magnet, a second magnet, and a third magnet, and where the first magnet is directly coupled with the first center pole piece and the second center pole piece, the second magnet is directly coupled with the second center pole piece opposite the first magnet, and the third magnet is directly coupled with the first center pole piece opposite the first magnet.

30. The loudspeaker driving motor of claim 29 further comprising a magnetic yoke outside the voice coil, where the magnetic yoke is operable to concentrate a magnetic flux of the first magnet, the second magnet, and the third magnet through the magnetic yoke.

31. The loudspeaker driving motor of claim 25 further comprising a support, where the one or more pole pieces comprises a central pole piece, where the central pole piece is indirectly coupled to the support inside the voice coil, and where the at least two magnets comprise a first magnet, a second magnet, and a third magnet, where the first magnet and the second magnet are directly coupled with the central pole piece, and the third magnet is directly coupled with the support.

32. The loudspeaker driving motor of claim 31 further comprising a first magnetic yoke and a second magnetic yoke, where the first magnetic yoke is directly coupled with a first side of the third magnet, and the second magnetic yoke is directly coupled with a second side of the third magnet, that is opposite the first side of the third magnet.

33. The loudspeaker driving motor of claim 32 where at least one of the first magnetic yoke or the second magnetic yoke is operable to concentrate in the gaps a magnetic flux of at least one of the first magnet, the second magnet, or the third magnet through at least one of the first magnetic yoke or the second magnetic yoke.

34. The loudspeaker driving motor of claim 25 further comprising:
a support, and where the one or more pole pieces comprise a first center pole piece and a second center pole piece, where the at least two magnets include a first magnet, a second magnet, and a third magnet, and where the first magnet is coupled with the first center pole piece and the second center pole piece, the second magnet is coupled with the support such that the voice coil is positioned between the first magnet and the second magnet, and where the third magnet is coupled with the support such that the voice coil is positioned between the first magnet and the third magnet.

35. The loudspeaker driving motor of claim 34 further comprising a magnetic yoke coupled with the support, where the magnetic yoke is operable to concentrate the magnetic flux of at least one of the first magnet, the second magnet, or the third magnet through the magnetic yoke.

36. The loudspeaker driving motor of claim 25 further comprising:
a frame; and
where the one or more pole pieces comprises a first center pole piece and a second center pole piece, where the at least two magnets comprise a first magnet, and a plurality of support magnets, where the first magnet is coupled with the first center pole piece and the second center pole piece; and where the support magnets are coupled with the frame.

37. The loudspeaker of claim 36 further comprising a first magnetic yoke and a second magnetic yoke coupled with the frame outside of the voice coil, and where the support magnets comprise a first support magnet, a second support magnet, and a third support magnet, and where the first support magnet is coupled with the frame between the first magnetic yoke and the second magnetic yoke, the second support magnet is coupled with the frame on a side of the first magnetic yoke that is opposite the first support magnet, and where the third support magnet is coupled with a side of the second magnetic yoke that is opposite the first support magnet.

38. The loudspeaker of claim 37 where at least one of the first magnetic yoke or the second magnetic yoke is operable to concentrate the magnetic flux of at least one of the first magnet, the first support magnet, the second support magnet, or the third support magnet through at least one of the first magnetic yoke or the second magnetic yoke.

39. A loudspeaker comprising:
a frame;
a first voice coil and a second voice coil resiliently coupled with the frame by a former;
one or more pole pieces positionable inside the first voice coil and the second voice coil to form at least two respective gaps between the one or more pole pieces and each of the first voice coil and the second voice coil;
at least two magnets, where a magnetic flux from each of the at least two magnets is directed within the at least two gaps; and
at least one magnetic yoke indirectly coupled to the at least two magnets and directly coupled with the frame, where the at least one magnetic yoke is operable to concentrate in the at least two gaps the magnetic flux of at least one of the at least two magnets through at least one of the at least one magnetic yoke.
